(19) United States
(12) Patent Application Publication
(10) Pub. No.: US 2004/0091410 A1
(43) Pub. Date: May 13, 2004

(54) Preparation method of inorganic compound

(75) Inventors: Hiroki Nakane, Tokyo (JP); Syoji Matsuzaka, Tokyo (JP)

Correspondence Address: MUSERLIAN AND LUCAS AND MERCANTI, LLP, 475 PARK AVENUE SOUTH, NEW YORK, NY, 10016, US

(73) Assignee: Konica Minolta Holdings, Inc., Tokyo (JP)

(21) Appl. No.: 10/695,841

(22) Filed: Oct. 29, 2003

(30) Foreign Application Priority Data
Nov. 7, 2002 (JP) JP2002-323647

(51) Int. Cl. C09K 11/08

(52) U.S. Cl. 423/263; 252/301.6 S; 252/301.4 P; 252/301.6 P; 252/301.4 H; 252/301.4 F; 252/301.6 F; 252/301.5; 423/300; 423/305; 423/326; 423/463; 423/464; 423/466; 423/489; 423/491; 423/497; 423/566.1; 423/561.1; 423/594.13

(57) ABSTRACT

A process of preparing an inorganic compound is disclosed, comprising the steps of (a) allowing at least an inorganic raw material compounds (A) and an inorganic raw material compound (B) which are different in solubility in water to react with each other in the presence of a reaction solvent with stirring to deposit an inorganic compound (C), while allowing a part of each of the compound (A) and compound (B) to exist as a solid; and

(b) separating the inorganic compound (C) from the reaction solvent. The process is applicable, for example, to preparation of a phosphor precursor of a rare earth activated alkaline earth metal fluorohalide.

### FIELD OF THE INVENTION

The present invention relates to a method for preparing inorganic compounds and in particular to a method for preparing rare earth activated alkaline earth met raw material (precursor).

### BACKGROUND OF THE INVENTION

There have been known a radiation image recording and reproducing method using stimulable phosphors as useful diagnosis means in place of conventional radiography, as described, for example, in JP-A No. 55-12145 (hereinafter, the term, JP-A means a Japanese Patent Application Publication). The method employs a radiation image conversion panel containing stimulable phosphors (also called cumulative phosphor sheet). Thus, radiation transmitted through an object or emitted from a test specimen is absorbed by a stimulable phosphor; subsequently, the stimulable phosphor is excited with an electromagnetic radiation such as visible light or ultraviolet light (also called exciting light) to radiate the accumulated radiation energy in the form of fluorescence (stimulated emission). The thus emitted fluorescence is photoelectrically read and converted to electric signals, followed by reproducing a radiation image of the object or the specimen, as a visible image, based on the electric signals. After completion of reading, the conversion panel is subjected to erasing remained images and used again for radiography.

This method has advantages that radiation images with a rich content of information are obtainable at extremely low exposure dose, as compared to the conventional radiography using the combination of radiographic film and an intensifying screen. In the conventional radiography, films are consumed for radiography; on the contrary, the radiation image conversion panel is repeatedly used, which is advantageous in terms of natural resource protection and economic efficiency.

The radiation image conversion panel comprises a stimulable phosphor layer provided on a support or a self-supporting stimulable phosphor layer. The stimulable phosphor layer is usually composed of a stimulable phosphor dispersed in a binder or stimulable phosphor coagulants formed by vapor deposition or calcination. There is also known coagulants which are interstitially impregnated with polymeric material. Further, a protective layer comprising polymer film or inorganic material-deposited film is usually provided on the opposite side of the support from the phosphor layer.

There are generally employed stimulable phosphors exhibiting stimulated emission in the range of 300 to 500 nm, excited by exciting light within the range of 400 to 900 nm, including rare earth element activated alkaline earth metal fluorohalide phosphors described in JP-A Nos. 55-12145, 55-160078, 56-74175, 56-116777, 57-23673, 57-23675, 58-206678, 59-27289, 59-27980, 59-56479 and 59-56480; divalent europium activated alkaline earth metal fluorohalide phosphors described in JP-A Nos. 59-75200, 60-84381, 60-106752, 60-166379, 60-221483, 60-228592, , 60-228593, 61-23679, 61-120882, 61-120883, 61-120885, 61-235486 and 61-235487; rare earth element activated oxyhalide phosphors described in JP-A No. 55-12144; cerium activated trivalent metal oxyhalide phosphors described in JP-A No. 58-69281; bismuth activated alkali metal halide phosphors described in JP-A No. 60-70484; divalent europium activated alkaline earth metal halophosphate phosphors described in JP-A Nos. 60-141783 and 60-157100; divalent europium activated alkaline earth metal haloborate phosphors described in JP-A No. 60-157099; divalent europium activated alkaline earth metal hydrogen halide phosphors described in JP-A No. 60-217354; cerium activated rare earth combined halide phosphors described in JP-A Nos. 61-21173 and 61-21182; cerium activated rare earth halophosphate phosphors described in JP-A No. 61-40390; divalent europium activated cerium-rubidium halide phosphors described in JP-A No. 60-78151; and divalent europium activated combined halide phosphors described in JP-A No. 60-78151. Specifically, there are known stimulable phosphors such as iodide containing divalent europium activated alkaline earth metal fluorohalide phosphors, iodide containing rare earth metal activated oxyhalide phosphors, and iodide containing bismuth activated alkali metal halide phosphors.

Methods for preparing stimulable phosphors include a solid phase process or so-called calcination method, and a liquid phase process in which a crystalline stimulable phosphor precursor is prepared in the liquid phase and the precursor is further calcined to obtain a stimulable phosphor. The solid phase process or calcination method necessitates pulverization after calcination, producing problems that it is difficult to control the grain shape or size which affects sensitivity or imaging performance. Fine particle formation of stimulable phosphors is an effective means to enhance image quality in radiation image conversion panels using stimulable phosphors.

JP-A 7-233369 and 9-291278 disclosed preparation of a stimulable phosphor in a liquid process, in which a fine particulate stimulable phosphor precursor was obtained by controlling the concentration of solution of phosphor raw material, providing a useful preparation method of stimulable phosphor precursors.

A precursor of an alkaline earth metal fluorohalide stimulable phosphor, prepared by the method described above was advantageous in luminance and graininess but preparation of a crystalline precursor in the liquid phase included the following problems. Thus, as described in JP-A Nos. 10-88125 and 9-291278, the following methods are useful:

(1) a method in which barium halide is dissolved in water or an organic solvent, followed by adding an inorganic fluoride solution with stirring;

(2) a method in which ammonium fluoride is dissolved in water, followed by adding barium halide with stirring.

However, the method (1) necessitated to allow a barium halide to be present in excess in the solution, often resulting in a reduced stoichiometrical ratio of barium fluorohalide obtained from the solution to barium halide, ca. 0.4. Thus, the yield of an alkaline earth metal fluoroiodide stimulable phosphor was often about 40% of a barium halide provided.

The method (2) also necessitated a barium halide in excess for an inorganic fluoride, leading to a low yield. As described above, synthesis of a stimulable phosphor precursor of an alkaline earth metal fluorohalide exhibited an extremely low yield, having problems such as low productivity.

To enhance the yield of a stimulable phosphor precursor of a rare earth metal activated alkaline earth metal fluorohalide, specifically, alkaline earth metal fluoroiodide stimulable phosphor precursor, JP-A No. 11-29324 disclosed a method of preparing square crystals of a rare earth element containing fluoroiodide, comprising a basic composition of BaFI:xLn (in which Ln is a rare earth element selected from Ce, Pr, Sm, Eu, Gd, Tb, Tm and Yb; 0<x≦0.1), in which a reaction mixture having a specified concentration was concentrated after adding a fluorine source. However, it was proved by the inventors of this application that although square-form BaFi crystals were formed according to the method taught in the foregoing patent document, concentration was performed by natural evaporation, leading to lowered productivity unacceptable in practical use. It was further proved that the thus obtained square-form crystals had relatively large sizes and a broad size distribution, resulting in inferior image qualities, which were unacceptable in practical use.

There were further disclosed methods for enhancing the yield of a stimulable phosphor precursor of a rare earth metal activated alkaline earth metal fluorohalide, specifically, alkaline earth metal fluoroiodide stimulable phosphor precursor, for example, in JP-A No. 2002-38143, in which the stoichiometrical ratio of the separated barium fluoride to the provided barium iodide was ca. 0.6, thus, the yield of an alkaline earth metal fluoroiodide stimulable phosphor being at an insufficient value of 60%.

In the foregoing methods of preparing phosphor precursors in the liquid phase, problems arose with a barium halide being needed in excess as raw material, leading to substantial waste of raw material, which was not preferable in terms of production efficiency. Furthermore, unreacted halide ions which remained in excess in the reaction system were incorporated into precipitates of the phosphor precursor, resulting in deteriorated performance, so that washing had to be carefully performed when separating the precursor from the reaction mixture solution.

### SUMMARY OF THE INVENTION

Accordingly, it is an object of the present invention to provide a method for preparing inorganic compounds with high yield and in particular to a method for preparing a precursor of crystalline rare earth-activated alkaline earth metal fluorohalide phosphor, which is formed at a high yield by effectively employing raw materials such as halide ions and alkaline earth metal ions and in which residues on reaction are minimized and washing can be easily carried out when separating the precursor from the reaction mixture solution.

The foregoing object of the invention can be accomplished by the following constitutions:

1. A process of preparing an inorganic compound comprising the steps of:

(a) allowing at least an inorganic compounds (A) and an inorganic compound (B) which are different in solubility in water to react with each other in the presence of a reaction solvent with stirring to deposit an inorganic compound (C), while at least a part of each of the compound (A) and at least a part of the compound (B) being allowed to exist as solids and

(b) separating the inorganic compound (C) from the reaction solvent.

### DETAILED DESCRIPTION OF THE INVENTION

In the invention, the process of preparing an inorganic compound through a liquid-phase reaction comprises (i) allowing at least two inorganic compounds (A) and (B) differing in solubility in water (for example, a relatively sparingly water-soluble inorganic raw material compound and a relatively easily water-soluble inorganic raw material compound) to react with each other in the presence of a reaction solvent with stirring to form an inorganic compound (C) precipitate and (ii) separating the inorganic compound (C) from the reaction solvent, while a part of the compound (A) and a part of the compound (B)being allowed to exist as solids. Thus, the inorganic compound (A) and the inorganic compound (B), each of which is in an amount exceeding its solubility in the solvent and is, in a part, a solid, are allowed to react with each other through the liquid-phase reaction in the presence of a reaction solvent to form an inorganic compound (C), which is in an amount exceeding its solubility in the solvent and is, in a part, a solid; and the solvent is present in a minimum amount necessary to maintain fluidity of the reaction mixture.

One aspect of this invention is that when at least two inorganic compounds as raw material are reacted with each other to form an inorganic compound as a product, reaction is conducted under the condition that inorganic compounds (A), (B) as raw material and an inorganic compound (C) as a reaction product are each in amounts exceeding the respective saturated concentrations, i.e., any one of the inorganic compounds (A), (B) and (C) partially exists in a solid form, concurrently in the presence of a reaction solvent in at least an amount capable of maintaining fluidity of the reaction mixture (or in an amount of capable of slurrying the reaction mixture). Thereby, the respective inorganic compounds as raw material effectively contribute the reaction, forming easily washable inorganic compound as a reaction product at a relatively high yield.

The expression, any one of the inorganic compounds (A), (B) and (C) partially existing in a solid form means that a part of each of the respective inorganic compounds is in a solid such as a powdery form or massive form and a reaction solvent is provided in an amount necessary to maintain fluidity of reaction mother liquor or slurrying the reaction mixture. In other words, inorganic compounds as raw material are supplied in large amounts exceeding saturated concentrations and the compounds exist in a solid form without being dissolved in the reaction solution. Herein, the inorganic compounds as raw material are those which supply main component elements forming the moiety of an inorganic compound as a product, so that inorganic compounds added as a modifier, such as an activator or dopant are excluded from the inorganic compounds as raw material. The inorganic compounds as raw material include their inorganic salts and hydrates.

In this invention, a sparingly water-soluble raw material, inorganic compound (A) is reacted with and an easily water-soluble raw material, inorganic compound (B) in the presence of a reaction solvent. Solvents usable as the reaction solvent include, for example, water, alcohol type organic solvents (e.g., methanol, ethanol, propanol, isopropanol, n-butanol, s-butanol, t-butanol, 2-methyl-2-butanol, cyclohexanol), ether type organic solvents (e.g., tetrahydrofuran, diisopropyl ether, ethylene glycol monomethyl ether, ethylene glycol monopropyl ether, ethylene glycol dimethyl ether, ethylene glycol monobutyl ether, anisole, dioxane, phenetol), ketone type organic solvents (e.g., acetone, methyl ethyl ketone, cyclohexanone), ester type organic solvents (e.g., propyl formate, butyl formate, methyl acetate, ethyl acetate, propyl acetate, ethylene glycol diacetate), and hydrocarbon type organic solvents (e.g., cyclohexane, cyclopentane, cycloheptane). A mixture of water and the foregoing organic solvents is preferred as a reaction solvent used in the invention. A mixture of water and the foregoing alcohol type solvents is more preferred, in which the content of water (the proportion of water by volume) is preferably no more than 80%, more preferably no more than 50%, and still more preferably no more than 30% by volume.

In this invention, at least one of reaction solvents is preferably one which has lower solubility than water for the inorganic compounds as raw material and the inorganic compound as product. Depending on the kind of inorganic compounds used as raw material and inorganic compounds as a product, the reaction solvent used in this invention is optimally selected from the fore going solvents (preferably organic solvents).

In the foregoing preparation method of this invention, it is preferred that an inorganic compound (A′) having a solubility in water of not more than 0.1 mol/l and an inorganic compound (B′) having a solubility in water of not less than 1 mol/l are used as the foregoing inorganic raw material compounds A and B, respectively, and the solubility in water of an inorganic compound as the reaction product falls between the solubility of the compound (A′) and that of the compound (B′). Conducting the reaction under the condition described above leads to easy washing and effective contribution of the respective raw material compounds to the reaction, producing the inorganic compound at high yield.

In one preferred embodiment of this invention, at least a part of the reaction solvent is water, and the amount of water is not more than 900 ml, preferably not more than 380 ml, and more preferably not more than 200 ml per mol of the entire raw material inorganic compounds. Performing the reaction under the condition described above renders easy washing and causes inorganic raw material compounds to effectively contribute the reaction, making it possible to obtain an inorganic product compound at high yield.

The present invention concerns a method for preparing an inorganic compound (designated C) through liquid phase reaction by allowing inorganic raw material compounds differing in solubility in water to react with each other, for example, by allowing at least a relatively sparingly water-soluble inorganic raw material compound (designated A) to react with at least a relatively water-soluble inorganic raw material compound (designated B) in the presence of water, wherein addition of the inorganic compounds (A and B), which depends on the kind of the compound, can be selected from various forms and addition patterns. Preferred examples of the embodiment of the form or addition of the inorganic compounds (A and B) are described below, but the invention is by no means limited to these.

Pattern of addition (1): a preparation process, in which all of inorganic compounds (A and B) are added in a solid form to a reaction vessel containing a reaction solvent to form reaction mother liquor containing solids of the inorganic compounds and then, reaction is allowed with stirring to form inorganic compound (C), while allowing at least a part of each of the inorganic compounds (A and B) exists in a solid form;

Pattern of addition (2): a preparation process, in which at least one of inorganic compounds (A and B) is added together with a reaction solvent to a reaction vessel so that at least a part of the one of inorganic compounds exists in a solid form and then, the other one of the inorganic compounds (A and B) is added thereto in a solid form to undergo reaction with stirring, while allowing at least a part of each of the inorganic compounds (A and B) to exist in a solid form;

Pattern of addition (3): a preparation process, in which at least inorganic compounds (A and B) are added in a solid form to a reaction vessel and mixed, then, a reaction solvent is further added thereto so that at least a part of each of the inorganic compounds (A and B) exists in a solid form and reaction is undergone with stirring to form inorganic compound (C), while allowing at least a part of each of the inorganic compounds (A, B) to exist in a solid form;

Pattern of addition (4): a preparation process, in which a reaction solvent is added to a reaction vessel and then, at least one of inorganic compounds (A and B) is added in a solid form to the reaction vessel with stirring, followed by adding the other one of inorganic compounds (A and B) in a solid form so that at least a part of each of the inorganic compounds (A and B) exists in a solid form, then, reaction is undergone with stirring to form inorganic compound (C), while allowing at least a part of each of the inorganic compounds (A, B) to exist in a solid form;

Pattern of addition (5): a preparation process, in which at least inorganic compounds (A and B) are simultaneously added in a solid form to a reaction vessel containing a reaction solvent with stirring to undergo reaction to form inorganic compound (C), while allowing at least a part of each of the inorganic compounds (A, B) to exist in a solid form;

Pattern of addition (6): a preparation process, in which a reaction solvent is added to a reaction vessel and thereto, inorganic compounds (A and B), which were previously mixed in a solid form, are added with stirring to undergo reaction to form inorganic compound (C), while allowing at least a part of each of the inorganic compounds (A and B) to exist in a solid form;

Pattern of addition (7): a preparation process, in which at least inorganic compounds (A and B) are simultaneously added to a reaction vessel provided with a stirring function and at least one of the inorganic compounds (A, B) forms a mixture with the reaction solvent, then reaction is undergone to form inorganic compound (C), while allowing at least a part of each of the inorganic compounds (A and B) to exist in a solid form;

Pattern of addition (8): a preparation process, in which a reaction solvent is added to a reaction vessel containing at least one of inorganic compounds (A, B) in a solid form, while stirring and then, the other one of the inorganic compound (A, B) is added thereto in a solid form to undergo reaction to form inorganic compound (C), while allowing at least a part of each of the inorganic compounds (A and B) to exist in a solid form;

Pattern of addition (9): a preparation process, in which one of inorganic compound (A and B) which was previously mixed with a reaction solvent is added to a reaction vessel containing the other one of inorganic compounds (A and B) in a solid form with stirring to undergo reaction to form inorganic compound (C), while allowing at least a part of each of the inorganic compounds (A and B) to exist in a solid form; Pattern of addition (10): a preparation process, in which at least inorganic compounds (A and B) in a solid form are mixed with stirring in a reaction vessel and further thereto, a mixture of at least one of the inorganic compounds (A, B) and reaction solvent is added to undergo reaction to form inorganic compound (C), while allowing at least a part of each of the inorganic compounds (A and B) to exist in a solid form;

Pattern of addition (11): any one of the foregoing preparation processes, in which at least one of the inorganic compounds (A and B) is comprised of a saturated solution of the inorganic compound and a solid.

The preparation process is optimally selected from the foregoing processes, depending on the kind of the inorganic compound (C) or desired characteristics, such as achieved grain size, grain size distribution and property of inorganic compound (C).

The preparation process of inorganic compounds, according to this invention is applicable to commonly known inorganic compounds, and to effectively display advantages of the invention, examples of preferred inorganic compounds include a zinc sulfide type phosphor precursor, a halophosphate type phosphor precursor, a phosphate type phosphor precursor, a silicate type phosphor precursor, a tungstate type phosphor precursor, an aluminate type phosphor precursor, and a rare earth activated alkaline earth metal halide type phosphor precursor. It is specifically preferred to apply to preparation of rare earth activated alkaline earth metal halide type phosphor precursors.

Next, preparation of a rare earth activated alkaline earth metal halide phosphor precursor will be described below. Rare earth activated alkaline earth metal halide phosphor precursors relating to this invention are preferably a rare earth activated alkaline earth metal fluorohalide phosphor precursor, and more preferably a rare earth activated alkaline earth metal fluorohalide stimulable phosphor precursor represented by the following formula (1):

Ba_{(1-y)}(M₂)_{y}FX:aM₁,bLn formula (1)

wherein X represents a halogen element selected from the group consisting of Cl, Br and I; M₂ represents an alkaline earth metal element selected from the group consisting of Be, Mg, Sr and Ca; M₁ represents an alkali metal element selected from the group consisting of Li, Na, K, Rb and Cs; Ln represents a rare earth element selected from the group consisting of Ce, Pr, Sm, Eu, Gd, Tb, Tm and Yb; y, a and b are 0≦y≦0.5, 0≦a≦0.05 and 0<b≦0.2.

The stimulable phosphor precursor described above refers to a state in which the compound represented by the foregoing formula (1) has not yet been subjected to heating at a temperature of 400° C. or more.

A process of preparing a crystalline rare earth-activated alkaline earth metal fluorohalide preferably comprises a precipitation step to allow a rare earth-activated alkaline earth metal fluorohalide to precipitate in reaction mother liquor and a post-step subsequent to the precipitation step which comprises separating precipitates from the reaction mother liquor, as described below.

Next, the foregoing respective steps are concretely described below.

Precipitation Step

The precipitation step is a process of allowing an inorganic halide and barium halide to react with each other to form a crystalline barium fluorohalide (BaFX) precipitate as a precursor of a stimulable phosphor.

Halogen elements of the barium halide include F, Cl, Br and I. F, Br and I are preferred when BaFx crystals are used as phosphor material. Preferred barium halides usable as raw material inorganic compound include barium fluoride, barium chloride, barium bromide, barium iodide an their hydrides. Halogen elements are optionally selected, depending on an intended product and plural halide elements are also usable. Barium halides are not limited to the foregoing halides and other barium halides are also usable in this invention.

One feature concerning this invention is that when mixed with a reaction solvent, the amount of a barium halide is more than its saturated concentration and a part of it exists in a solid form in solution. For example, the amount of barium fluoride is more than 0.01 moles per liter of solution (also denoted as mol/l), that of barium chloride or barium bromide is more than 2.6 mol/l, and that of barium iodide is more than 5.1 mol/l. Specifically, barium fluoride is preferably more than 0.1 mol/l, and more preferably more than 1.0 mol/l; barium iodide is preferably more than 6.0 mol/l, and more preferably more than 7.0 mol/l. The upper limit of a barium halide in the reaction mixture, which is variable with the kind of a solvent, is a quantity at which fluidity of the reaction mixture is lost or stirring the reaction mixture becomes infeasible. As described above, the amount (expressed in mol/l) means a quantity of an inorganic compound as raw material, expressed in terms of the number of moles of the inorganic compound per liter of a solvent.

Examples of inorganic halides usable in this invention include ammonium fluoride, sodium fluoride, potassium fluoride, calcium fluoride, magnesium fluoride, strontium fluoride, barium fluoride, and bromides and iodides in which the foregoing fluorides were replaced by bromides or iodides. Of these halides described above, ammonium fluoride, ammonium chloride, ammonium bromide, ammonium iodide, barium fluoride, barium chloride, barium bromide, and barium iodide are preferred. Halogen elements are optionally selected, depending on an intended product and plural halide elements are also usable. Inorganic halides are not limited to the foregoing halides and other inorganic halides are also usable in this invention.

When mixed with a reaction solvent, the amount of an inorganic halide is more than its saturated concentration and a part of it preferably exists in a solid form in solution. The upper limit of an inorganic halide in the reaction mixture, which is variable with the kind of a solvent used therein, is a quantity at which fluidity of the reaction mixture is lost or stirring the reaction mixture becomes infeasible. The molar ratio of fluorine to other halogens contained in all of inorganic compounds as raw material (e.g., molar ratio of fluorine/bromine and iodine in BaFX) is preferably 0.5 to 2.0, more preferably 0.65 to 1.54, and still more preferably 0.75 to 1.33. The molar ratio of fluorine to barium contained in all of inorganic compounds as raw material (e.g., molar ratio of fluorine/barium in BaFX) is preferably 0.5 to 2.0, more preferably 0.65 to 1.54, and still more preferably 0.75 to 1.33.

An inorganic halide, barium halide and reaction solvent can be added in accordance with addition patterns described earlier or in other various manners. Addition may be carried out continuously or intermittently (i.e., after continuing addition over a prescribed period of time, the addition stops over a period of time and such sequence is repeated). For example, in the case of plural inorganic compounds used as raw material, the inorganic compounds are added alternately and intermittently.

Activators are further added to provide fluorescence or phosphorescence properties to BaFx crystals obtained in this invention. An activator may be added at any time and is preferably added to a solvent simultaneously with or before addition of inorganic compounds as raw material. Alternatively, the activator may be added to inorganic compounds as raw material. Preferred activators include, for example, halides of Ce, Pr, Sm, Eu, Gd, Tb, Tm and Yb. Halogen elements are optionally selected, depending on an intended product. In the case of BAFI, for example, europium iodide or cerium iodide is preferable. The activator content can be optimized according to intended performance.

Other components can optionally be selected from alkali metals such as Li, Na, K, Rb and Cs and alkaline earth metals such as Mg, Ca and Sr. These compounds can be added similarly to the foregoing activators with respect to addition manner, timing and amount.

When the foregoing component compounds are mixed to form a precipitate, the reaction mixture is maintained preferably at a temperature (reaction temperature) of 0 to 100° C. There may further be added a small amount of an acid, ammonia, water-soluble polymer or a surfactant.

Separation Step

The separation step is a process of separating a crystalline BaFX precipitate formed through the foregoing precipitation step, from reaction mixture (or reaction mother liquor), which is preferably provided as a post-step subsequent to the precipitation step. The formed precipitate is separated by filtration or centrifugal separation, followed by being sufficiently washed with organic solvents such as ethanol and isopropyl alcohol and dried.

A precursor of a rare earth activated alkali metal halide phosphor, obtained according to the method of this invention exhibits superior washing efficiency, in which washing is achieved using a solvent in a smaller amount and at a higher cleaning degree, as compared to the conventional liquid phase process.

A rare earth activated alkali metal halide phosphor precursor obtained according to this invention preferably has an average grain size of 1 to 10 μm. The average grain size is an average value of sphere equivalent diameters (diameter of a sphere having a volume equivalent to the grain) of 200 grains selected at random from an electron micrograph of the grains.

The thus obtained rare earth activated alkali metal halide phosphor precursor is further subjected to calcination according to methods known in the art to obtain stimulable phosphor particles. The obtained stimulable phosphor particles are used for a radiation image conversion panel.

### EXAMPLES

The present invention will be further described based on examples but embodiments of the invention are by no means limited to these.

### Example 1

### Preparation of Stimulable Phosphor Precursor

Stimulable phosphor precursors were synthesized according to the following manner.

Synthesis of Stimulable Phosphor Precursor 1

A precursor of stimulable phosphor, europium activated barium fluoroiodide was prepared according to the following procedure. T a reaction vessel were added 2380 ml of aqueous BaI₂ solution (4.2 mol/l) and 27 ml of aqueous EuI₃ solution (0.2 mol/l). Reaction mother liquor in the reaction vessel was maintained at a temperature of 83° C. with stirring and further thereto 200 ml of an aqueous ammonium fluoride solution (13 mol/l) was added over a period of 30 min. using a roller pump to form a precipitate. After completion of addition, the reaction mixture was further stirred with maintaining the temperature for 2 hr. to ripen the precipitate. Subsequently, the precipitate was separated by filtration, washed with 1600 ml of ethanol and dried in vacuo to obtain a precursor of europium activated barium fluoroiodide stimulable phosphor (precursor 1).

Synthesis of Stimulable Phosphor Precursor 2

Synthesis was conducted in accordance with the afore-mentioned pattern of addition (8). Thus, 99.4 g of powdery BaF₂ was added to a 1 liter conical reaction vessel provided with stirrer. Then, 1.2 g of EuI₃ dispersed in 82 ml reaction solvent (ethanol/water =3/1) was added thereto and slurried with solid powdery BaF₂, while stirring. Thus obtained BaF₂ slurry was maintained at 60° C. Subsequently, to the BaF₂ slurry, 296.0 g of powdery BaI₂.2H₂O was in limited amounts and slurried with stirring. The reaction mixture was further maintained at 60° C. for 2 hr. with stirring to form crystals of BaFI:Eu. The formed crystals were separated by filtration, washed with 1600 ml of ethanol and dried in vacuo to obtain a precursor of europium activated barium fluoroiodide stimulable phosphor (denoted as precursor 2).

Synthesis of Stimulable Phosphor Precursor 3

Synthesis was conducted in accordance with the afore-mentioned pattern of addition (1). Thus, 1.2 g of EuI₃ dispersed in 82 ml reaction solvent (ethanol/water =3/1) was added to a 1 liter conical reaction vessel provided with stirrer and 99.4 g of powdery BaF₂ was further added thereto and slurried with stirring, while being maintained at 60° C. Subsequently, to the slurry, 296.0 g of powdery BaI₂.2H₂O was in limited amounts and slurried with stirring. The reaction mixture (slurry) was further maintained at 60° C. for 2 hr. with stirring to form crystals of BaFI:Eu. The formed crystals were separated by filtration, washed with 1600 ml of ethanol and dried in vacuo to obtain a precursor of europium activated barium fluoroiodide stimulable phosphor (denoted as precursor 3).

Synthesis of Stimulable Phosphor Precursor 4

Synthesis was conducted in accordance with the afore-mentioned pattern of addition (3). Thus, to a 1 liter conical reaction vessel provided with stirrer were simultaneously added 99.4 g of powdery BaF₂ and 296.0 g of powdery BaI₂.2H₂O. After mixing with stirring, 1.2 g of EuI₃ dispersed in 82 ml reaction solvent (ethanol/water =3/1) was added thereto, mixed with powdery BaF₂ and BaI₂.2H₂O and slurried with stirring. The reaction mixture (slurry) was further maintained at 60° C. for 2 hr. with stirring to form crystals of BaFI:Eu. The formed crystals were separated by filtration, washed with 1600 ml of ethanol and dried in vacuo to obtain a precursor of europium activated barium fluoroiodide stimulable phosphor (denoted as precursor 4).

Synthesis of Stimulable Phosphor Precursor 5

Synthesis was conducted in accordance with the afore-mentioned pattern of addition (6). Thus, to a 1 liter conical reaction vessel provided with stirrer was added 1.2 g of EuI₃ dispersed in 82 ml reaction solvent (ethanol/water =3/1) and further thereto, a powdery mixture of 99.4 g of BaF₂ and 296.0 g of BaI₂.2H₂O was added, mixed and slurried with stirring. The reaction mixture (slurry) was further maintained at 60° C. for 2 hr. with stirring to form crystals of BaFI:Eu. The formed crystals were separated by filtration, washed with 1600 ml of ethanol and dried in vacuo to obtain a precursor of europium activated barium fluoroiodide stimulable phosphor (denoted as precursor 5).

Synthesis of Stimulable Phosphor Precursor 6

Synthesis was conducted in accordance with the afore-mentioned pattern of addition (7). Thus, to a 1 liter conical reaction vessel provided with stirrer, a slurry obtained by mixing 99.4 g of powdery BaF₂ with 1.2 g of EuI₃ dispersed in 82 ml reaction solvent (ethanol/water =3/1) and 296.0 g of powdery BaI₂.2H₂O were simultaneously added and slurried with stirring. The reaction mixture (slurry) was further maintained at 60° C. for 2 hr. with stirring to form crystals of BaFI:Eu. The formed crystals were separated by filtration, washed with 1600 ml of ethanol and dried in vacuo to obtain a precursor of europium activated barium fluoroiodide stimulable phosphor (denoted as precursor 6).

Synthesis of Stimulable Phosphor Precursor 7

Synthesis was conducted in accordance with the afore-mentioned pattern of addition (9). Thus, to a 1 liter conical reaction vessel provided with stirrer, 99.4 g of powdery BaF₂ was added, then, 1.2 g of EuI₃ dispersed in 82 ml reaction solvent (ethanol/water =3/1) and 296.0 g of powdery BaI₂.2H₂O were added and slurried with stirring. The reaction mixture (slurry) was further maintained at 60° C. for 2 hr. with stirring to form crystals of BaFI:Eu. The formed crystals were separated by filtration, washed with 1600 ml of ethanol and dried in vacuo to obtain a precursor of europium activated barium fluoroiodide stimulable phosphor (denoted as precursor 7).

Synthesis of Stimulable Phosphor Precursor 8

Synthesis was conducted in accordance with the afore-mentioned pattern of addition (4). Thus, to a 1 liter conical reaction vessel provided with stirrer, 1.2 g of EuI₃ dispersed in 82 ml reaction solvent (ethanol/water =3/1) was added and then, 296.0 g of powdery BaI₂.2H₂O was added and slurried with stirring. Further thereto, 99.4 g of powdery BaF₂ was added and slurried with stirring. The reaction mixture (slurry) was further maintained at 60° C. for 2 hr. with stirring to form crystals of BaFI:Eu. The formed crystals were separated by filtration, washed with 1600 ml of ethanol and dried in vacuo to obtain a precursor of europium activated barium fluoroiodide stimulable phosphor (denoted as precursor 8).

Synthesis of Stimulable Phosphor Precursor 9

Similarly to the foregoing precursor 2, synthesis was conducted in accordance with the afore-mentioned pattern of addition (8), except that the amount of added BaF₂ was changed to 121.5 g. A precursor of europium activated barium fluoroiodide stimulable phosphor was thus obtained (precursor 9).

Synthesis of Stimulable Phosphor Precursor 10

Similarly to the foregoing precursor 2, synthesis was conducted in accordance with the afore-mentioned pattern of addition (8), except that the amount of the reaction solvent (ethanol/water =3/1) was changed to 164 ml. A precursor of europium activated barium fluoroiodide stimulable phosphor was thus obtained (precursor 10).

Synthesis of Stimulable Phosphor Precursor 11

Similarly to the foregoing precursor 2, synthesis was conducted in accordance with the afore-mentioned pattern of addition (8), except that the amount of the reaction solvent (ethanol/water =3/1) was changed to 50 ml. A precursor of europium activated barium fluoroiodide stimulable phosphor was thus obtained (precursor 11).

Synthesis of Stimulable Phosphor Precursor 12

Similarly to the foregoing precursor 2, synthesis was conducted in accordance with the afore-mentioned pattern of addition (8), except that the ratio of ethanol/water of the reaction solvent was changed to ethanol/water =3/2. A precursor of europium activated barium fluoroiodide stimulable phosphor was thus obtained (precursor 12).

Synthesis of Stimulable Phosphor Precursor 13

Similarly to the foregoing precursor 2, synthesis was conducted in accordance with the afore-mentioned pattern of addition (8), except that the amount of the reaction solvent (ethanol/water =3/1) was changed to 560 ml to dissolver all of powdery BaI₂.2H₂O. A precursor of europium activated barium fluoroiodide stimulable phosphor was thus obtained (precursor 13).

Synthesis of Stimulable Phosphor Precursor 14

To a pressure-tight reaction vessel were added 2500 ml of an aqueous BaI₂ solution (4 mol/l) and 26.5 ml of an aqueous EuI₃ solution (0.2 mol/l). Further thereto, 992 g of potassium iodide was added and maintained at 83° C. with stirring. Ten, 600 ml of an aqueous ammonium fluoride solution (10 mol/1) was added thereto using a roller pump to form a precipitate. The reaction mixture was further stirred for 90 min. Thereafter, the precipitate was separated by filtration and washed with ethanol to obtain a precursor of europium activated barium fluoroiodide stimulable phosphor (denoted as precursor 14).

Synthesis of Stimulable Phosphor Precursor 15

To a 300 ml separable beaker, 150 ml of an aqueous BaI₂ solution (4 mol/l) was added, then, 3 ml of a EuI₃ solution (0.1 mol/l) and 47 ml of water were added thereto, and 50 ml of an aqueous ammonium fluoride solution (6 mol/1) was further added and maintained at 80 ° C. To the thus prepared solution, 50 g of Teflon (R) boiling stone (available from Chem-Wear Co.) was added and reaction continued for 2 hr. with stirring, while being evacuated with an aspirator to obtain a precipitate of europium activated barium fluoroiodide phosphor precursor (particulate BaFI:Eu). After completion of reaction, Teflon (R) boiling stone was separated using a stainless steel mesh with a 1 mm aperture and then, the precipitate was separated by suction filtration using filter paper. The separated precipitate was washed by uniformly sprinkling 300 ml of isopropyl alcohol (IPA) and dried in vacuo at 150° C. over a period of 2 hr. to obtain a precursor of europium activated barium fluoroiodide stimulable phosphor (denoted as precursor 15).

### Evaluation of Stimulable Phosphor Precursor

Determination of Yield

Amounts of Ba added in the respective syntheses were determined and amounts of Ba contained in the respective europium activated barium fluoroiodide phosphor precursors were determined by X-ray diffractometry to calculate the yield for the respective syntheses.

Measurement of Washing Degree

The free-iodine content of the europium activated barium fluoroiodide phosphor precursor was determined as a measure of washing degree, according to the following procedure. The less free0iodine content indicates the higher washing degree.

Each of the prepared particulate precursors of europium activated barium fluoroiodide phosphors was precisely weighed by 1 g, added to 10 ml ethanol and dispersed using a ultrasonic homogenizer over a period of 30 sec. to prepare dispersion. Subsequently, after treating with a chromato disc, 1 ml of the dispersion was put into a 10 ml mess-flask, 1 ml of a 1000 ppm sulfite ion solution was added and ultrapure pure water was added to make up a solution of 10 ml. The quantity (mg/g sample) of iodide ions contained in the solution containing ethanol-soluble components was determined through ion chromatography.

The thus obtained results are shown in Table 1.

TABLE 1

Characteristic Value

| Precursor | Pattern | Yield | Washing | |
|---|---|---|---|---|
| No. | No. | (%) | Degree (mg/g) | Remark |
| 1 | — | 33 | 1.89 | Comp. |
| 2 | 8 | 84 | 1.25 | Inv. |
| 3 | 1 | 73 | 1.31 | Inv. |
| 4 | 3 | 79 | 1.27 | Inv. |
| 5 | 6 | 74 | 1.29 | Inv. |
| 6 | 7 | 82 | 1.25 | Inv. |
| 7 | 9 | 80 | 1.26 | Inv. |
| 8 | 4 | 78 | 1.31 | Inv. |
| 9 | 8 | 95 | 1.19 | Inv. |
| 10 | 8 | 75 | 1.31 | Inv. |
| 11 | 8 | 85 | 1.23 | Inv. |
| 12 | 8 | 85 | 1.25 | Inv. |
| 13 | 8 | 60 | 1.64 | Comp. |
| 14 | — | 57 | 1.71 | Comp. |
| 15 | — | 42 | 1.97 | Comp. |

As apparent from Table 1, it was proved that precursors of europium activated barium fluoroiodide phosphors (BaFI:Eu particles), prepared in the process according to this invention were obtained at a high yield, exhibiting superior washability and high purity, compared to samples of comparison.

### Example 2

Similarly to Example 1, particulate precursors of europium activated barium fluorobromide phosphors (BaFBr:Eu particles) were prepared, except that BaI₂ was replaced by BaBr₂. The thus prepared precursors were evaluated similarly to Example 1 with respect to yield and purity. As a result, it was proved that precursors of europium activated barium fluorobromide phosphors, prepared in the process according to this invention were obtained at a high yield, exhibiting superior washability and high purity.

What is claimed is:

1. A process of preparing an inorganic compound comprising the steps of:
(a) allowing at least an inorganic compounds (A) and an inorganic compound (B) which are different in solubility in water to react with each other in the presence of a reaction solvent with stirring to deposit an inorganic compound (C), while allowing at least a part of each of the compound (A) and compound (B) to exist as a solid and
(b) separating the inorganic compound (C) from the reaction solvent.

2. The process of claim 1, wherein the compound (A) exhibits a solubility in water of not more than 0.1 mol/l at 25° C. and the compound (B) exhibits a solubility in water of not less than 1.0 mol/l at 25° C., and a solubility of the compound (C) at 25° C. being between the solubility in water of the compound (A) and that of the compound (B).

3. The process of claim 1, wherein the reaction solvent contains water in an amount of not more than 900 ml per mol of the compound (A) and the compound (B).

4. The process of claim 3, wherein said water is contained in an amount of not more than 380 ml per mol of the compound (A) and the compound (B).

5. The process of claim 3, wherein said water is contained in an amount of not more than 200 ml per mol of the compound (A) and the compound (B).

6. The process of claim 3, wherein the reaction solvent further contains at least an organic solvent and the compound (A), compound (B) and compound (C) each exhibit a solubility in the organic solvent lower than a solubility in water.

7. The process of claim 1, wherein in step (a), the reaction solvent is added into a reaction vessel and then a solid of the compound (A) and a solid of the compound (B) are each added into the reaction vessel, and after completion of addition, a part of each of the compound (A) and compound (B) exists as a solid in the reaction vessel.

8. The process of claim 1, wherein in step (a), a solid of one of the compound (A) and the compound (B) and the reaction solvent are mixed in the reaction vessel so that the a part of the one of the compound (A) and the compound (B) exist as a solid and then the other one of the compound (A) and the compound (B) is further added to the reaction vessel, and after completion of addition, a part of each of the compound (A) and compound (B) exists as a solid in the reaction vessel.

9. The process of claim 1, wherein in step (a), a solid of the compound (A) and a solid of the compound (B) are added into a reaction vessel and then the reaction solvent is further added to the reaction vessel with stirring, and after completion of addition, a part of each of the compound (A) and compound (B) exists as a solid in the reaction vessel.

10. The process of claim 7, wherein a solid of one of the compound (A) and the compound (B) is added into the reaction vessel containing the reaction solvent and then a solid of the other one of the compound (A) and the compound (B) is further added thereto.

11. The process of claim 7, wherein a solid of the compound (A) and a solid of the compound (B) are simultaneously added to the reaction vessel containing the reaction solvent.

12. The process of claim 7, wherein a solid of the compound (A) and a solid of the compound (B) which were previously mixed with each other are added into the reaction vessel containing the reaction solvent.

13. The process of claim 7, wherein one of the compound (A) and the compound (B) which was previously mixed with the reaction solvent and the other one of the compound (A) and the compound (B) are simultaneously added to the reaction vessel.

14. The process of claim 8, wherein one of the compound (A) and the compound (B) is added into the reaction vessel, then, the reaction solvent is added to the reaction vessel and the other one of the compound (A) and the compound (B) is further added thereto.

15. The process of claim 8, wherein one of the compound (A) and the compound (B) is added into the reaction vessel and the other one of the compound (A) and the compound (B) and the reaction solvent which were previously mixed with each other are added into the reaction vessel.

16. The process of claim 9, wherein the reaction solvent which was previously mixed with an inorganic compound.

17. The process of claim 1, wherein each of the compound (A) and the compound is mixed with the reaction solvent so that a part of the compound exists as a solid is added to the reaction vessel.

18. The process of claim 1, wherein the compound (C) is a zinc sulfide phosphor precursor.

19. The process of claim 1, wherein the compound (C) is a halophosphate phosphor precursor.

20. The process of claim 1, wherein the compound (C) is a phosphate phosphor precursor.

21. The process of claim 1, wherein the compound (C) is a silicate phosphor precursor.

22. The process of claim 1, wherein the compound (C) is a tungstate phosphor precursor.

23. The process of claim 1, wherein the compound (C) is an aluminate phosphor precursor.

24. The process of claim 1, wherein the compound (C) is a rare earth activated alkali metal halide phosphor precursor.

25. The process of claim 1, wherein the compound (C) is a rare earth activated alkaline earth metal fluorohalide phosphor precursor.

26. The process of claim 25, wherein the rare earth activated alkaline earth metal fluorohalide phosphor precursor is represented by the following formula (1):
Ba_{(1-y)}(M₂)_{y}FX:aM₁,bLn formula (1)
wherein X represents a halogen element selected from the group consisting of Cl, Br and I; M₂ represents an alkaline earth metal element selected from the group consisting of Be, Mg, Sr and Ca; M₁ represents an alkali metal element selected from the group consisting of Li, Na, K, Rb and Cs; Ln represents a rare earth element selected from the group consisting of Ce, Pr, Sm, Eu, Gd, Tb, Tm and Yb; y, a and b are 0≦y≦0.5, 0≦a≦0.05 and 0<b≦0.2.

27. The process of claim 25, wherein at least one of the compound (A) and the compound (B) is an inorganic halide compound.

28. The process of claim 25, wherein at least one of the compound (A) and the compound (B) is a barium halide.

29. The process of claim 25, wherein at least the compound (A) and the compound (B) are barium halides.

30. The process of claim 29, wherein the inorganic halide compound is BaF₂ or BaI₂.

31. The process of claim 30, wherein a solid of BaF₂ is added to the reaction solvent containing BaI₂ of at least 5.1 mol per liter of the reaction solvent.

32. The process of claim 30, wherein a solid of BaI₂ is added to the reaction solvent containing BaF₂ of at least 0.1 mol per liter of the reaction solvent.

33. The process of claim 30, wherein the inorganic halide is BaF₂ and BaI₂, and an atomic ratio (f/I) of fluorine (f) contained in the BaF₂ to iodine (i) contained in the BaI₂ is 0.5 to 2.0.
